(19) United States
(12) Patent Application Publication
(10) Pub. No.: US 2006/0190537 A1
(43) Pub. Date: Aug. 24, 2006

(54) Method and system for enabling structured real-time conversations between multiple participants

(76) Inventor: Robert P. Morris, Raleigh, NC (US)

Correspondence Address: SCENERA RESEARCH, LLC, 111 Corning Road, Suite 220, Cary, NC, 27511, US

(21) Appl. No.: 11/065,510

(22) Filed: Feb. 23, 2005

(51) Int. Cl. G06F 15/16

(52) U.S. Cl. 709/204

(57) ABSTRACT

The present invention provides a method and system for enabling a structured real-time network communication session for at least two or more client devices. Aspects of the invention include providing a server with one or more conversation applications that provide respective structured conversations; displaying a list of available structured conversations on at least one of the client devices for selection; and in response to the server receiving the selection of one of the structured conversations, passing control of the conversation to the corresponding conversation application.

### FIELD OF THE INVENTION

The present invention relates to online digital image sharing, and more particularly to a method and system for enabling structured real-time conversations between multiple participants.

### BACKGROUND OF THE INVENTION

Instant messaging systems that are capable of displaying image data are known. For example, U.S. Patent Application Publication US 2004/0177116 to McConn et al., entitled “Digital Image Sharing Enable Chat Application” provides a PC-based digital image sharing application that provides both real-time chatting and photosharing support. First, a client wishing to share digital graphic images, referred to as the sharer, and a client with whom the digital images are to be shared, referred to as the sharee, each launch a respective instant Internet messaging service, establishing themselves as being available to begin a chat session. Prior to initiating the chat session, the sharee uses the digital image sharing application to select a specific image from an album (or the entire album) to share from an album manager and to select the sharee from a buddy list. After the sharer chooses a name from the buddy list, a chat session is initiated between the sharer and the sharee.

Upon initiation of the chat session, a chat window is opened on the client computer of the sharer that contains five sections. The first section contains a view of the selected digital image, the second section contains a description associated with the image, the third section contains thumbnail images of the images in the album, the fourth section contains a catalog displaying a running history of the current conversation, and the fifth section contains a message composition area in which the sharer composes the message to be sent to the sharee. A real-time conversation is initiated when the sharer completes a message in the message composition area, which also initiates transmission of the selected album to the client computer of the sharee. When the client computer of the sharee receives the message and photographic image, a chat window as described above opens on the sharee's client computer. The sharee accepts the received request by replying with a message. The sharer and sharee then proceed to discuss the digital photographic image in real-time. At any time during the conversation, another image may be selected from the album, and the newly selected image is displayed in the first section of the chat window.

Although McConn's digital image sharing application is an improvement over text-based chat applications, McConn shares some disadvantages of conventional chat applications. One disadvantage is that the conversations people have using chat applications are free-flowing, often jumping from one topic to the next. As a result of the unstructured conversations, both parties may end up retyping much of the content. In addition, because of the inherent delays between the time it takes one person to compose and send a response message, the messages exchanged during the conversations often become unsynchronized and difficult to follow.

Accordingly, what is needed is a method and system for enabling structured real-time conversations between multiple participants in a manner that reduces the disadvantages described above. The present invention addresses such a need.

### BRIEF SUMMARY OF THE INVENTION

The present invention provides a method and system for enabling a structured real-time network communication session for at least two or more client devices. Aspects of the invention include providing a server with one or more conversation applications that provide respective structured conversations; displaying a list of available structured conversations on at least one of the client devices for selection; and in response to the server receiving the selection of one of the structured conversations, passing control of the conversation to the corresponding conversation application.

According to the method and system disclosed herein, the preferred embodiment combines aspects of web applications and interactive communications such as chat conversations, instant message (IM), and voice applications, such that the real-time conversation between two or more people is structured like the interaction with a web site, but the interactivity involves at least two people rather than just one person with a web site.

### BRIEF DESCRIPTION OF SEVERAL VIEWS OF THE DRAWINGS

FIG. 1 is a flow diagram illustrating a process for enabling a structured real-time network communication session for at two or more client devices according to preferred embodiment of the present invention.

FIG. 2 is a block diagram illustrating a system for enabling structured real-time network communication session in accordance with a preferred embodiment of the present invention.

FIG. 3 is a flow diagram illustrating the process for providing structured conversation sessions using conversation applications 36 in one embodiment of the present invention.

FIG. 4 is a flow diagram illustrating the process of a structured conversation session provided by the photo album conversation application 36a in accordance with a preferred embodiment.

### DETAILED DESCRIPTION OF THE INVENTION

The present invention relates to structured real-time conversations between multiple participants. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

In light of the observation that there may be a common set of discussion topics/actions people would like have/do during real-time conversations regarding shared images, the present invention provides a method and system for enabling structured real-time conversations regarding shared digital images. The architecture of the present invention provides a framework for building any type of structured real-time conversation between two or more participants over a network. More specifically, the present invention provides conversation applications that use IM/chat or other real-time communication sessions to send structured display and input forms to the client devices that allow a participant to share multimedia objects and text messages with other participants in a structured manner and that simultaneously prompt the participants to enter specific information at specific times, thereby guiding the participant interactions in a structured manner. For example, a structured photo sharing conversation application that displays an album to chat participants, may display a form that allows participants to request prints or to order a book of an album during the ongoing IM/chat session, rather than simply allowing the participants to enter general comments about the photos. It may also allow the conversation leader to control the format and sequence of the display of images in the album or allow each participant some control over the format of the displayed images.

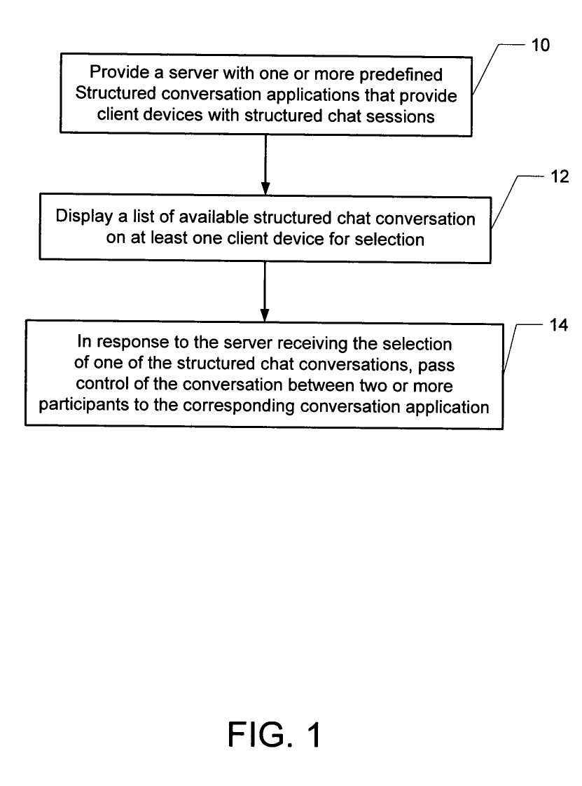

FIG. 1 is a flow diagram illustrating a process for enabling a structured real-time network communication session for at least two or more client devices according to preferred embodiment of the present invention. The present invention applies to real-time communication sessions over a network, such as a chat conversation, instant messaging, and voice messaging, for example. The process begins in step 10 by providing a server with one or more predefined structured conversation applications that provide client devices with structured chat sessions. In step 12, a list of available structured chat conversations is displayed on at least one of the client devices for participant selection. In step 14, in response to the server receiving the participant selection of one of the structured chat conversations, the server passes control of the conversation between participants of the client devices to the corresponding conversation application. After control is passed, the conversation application manages communication between the participants of the client devices by using the real-time communication session to send media rich display content with input forms to the client devices to allow the initiating participant to share multimedia objects and text with recipient participants. The input forms restrict the participant's input by prompting for specific information at specific states of the conversation, thereby guiding participant responses in a structured manner.

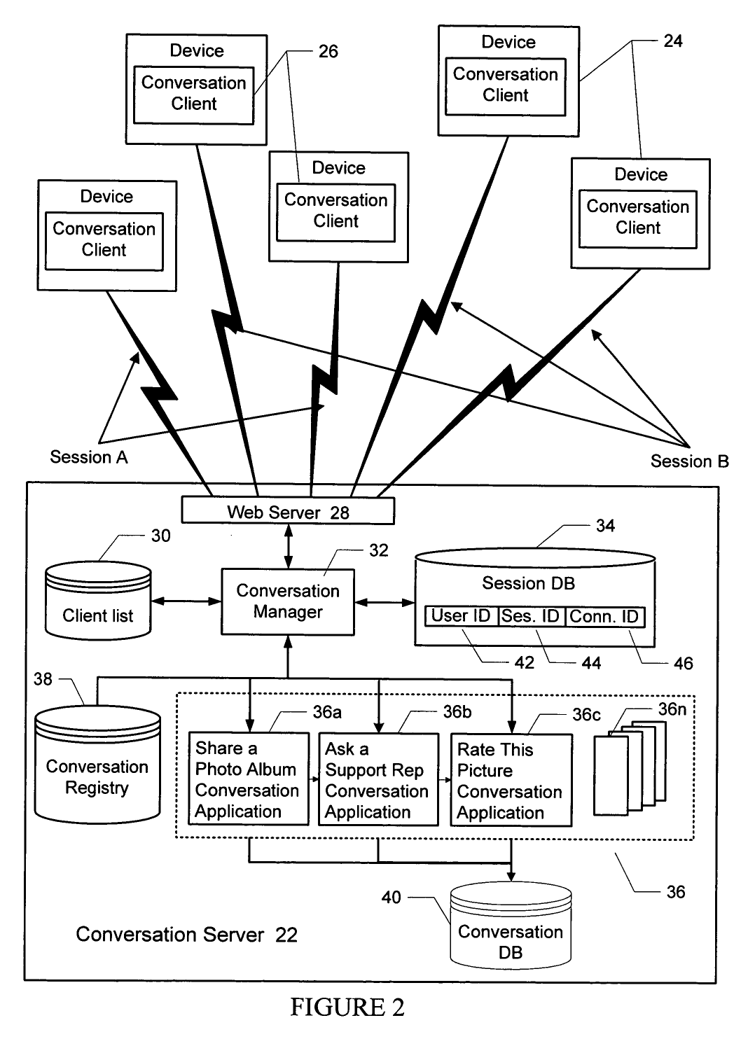

FIG. 2 is a block diagram illustrating a system for enabling structured real-time network communication session in accordance with a preferred embodiment of the present invention. The system 20 includes a conversation server 22 that provides structured chatting with images to client devices 24 of multiple participants (not shown). Each of the multiple client devices 24 is capable of communication with the conversation server 22 over a network (wired or wireless), such as the Internet, and includes a conversation client application 26 that provides real-time communication functionality. Similar to an instant messaging application, the conversation client application 26 includes a component that maintains a persistent connection with the conversation server 22.

The conversation server 22 includes a web server 28, a client list 30, a conversation manager 32, a session database 34, a conversation registry 38, and multiple conversation applications 36. The various components of the conversation server 22 may reside on the same or different computers. The conversation server 22 provides the conversation applications 36 with real-time communication functionality to allow the applications 36 to participate in communication sessions between two or more participants to control the communication between the participants and to display rich media in a structured way to all participants of the conversation through the conversation clients 26. The conversation server 22 may be implemented as a web server or a session initiation protocol (SIP) proxy server. A SIP server designed primarily for setting up IP telephony, but can be used to set up any type of connection, such as instant messaging using SIMPLE (SIP for Instant Messaging and Presence Leveraging Extensions) for IM and presence. SIP proxy servers have been used for instant messaging to route messages between two participants and to perform additional processing. In the present invention, the additional processing includes invoking the appropriate conversation application 36.

The web server 28 manages requests from the conversation clients 26 on the client devices 24, which are preferably browser-based or contain embedded browser components, and delivers HTML documents and files from the conversation applications 36. The web server 28 may also execute server-side scripts (CGI scripts, JSPs, ASPs, etc.) that provide functions, such as database searching and e-commerce.

The client list 30, conversation manager 32, and session database 34 are components used by the conversation server 22 to keep track of the participants of the conversations taking place between the client devices 24. The client list 30 is used by the conversation clients 26 at the outset of a conversation to display a list of available participants online such as a friends list. The conversation manager 32 manages the persistent connections between multiple participants by maintaining records of all participants involved in an open conversation in the session database 34. This may be done using IP addresses, but in a preferred embodiment, this is accomplished by associating each of the participants of a conversation with a session ID. If the client device 24 is behind a firewall, then the client device 24 must open the connection with the conversation server 22, otherwise, the connection can be opened by the conversation server 22 as needed.

The conversation registry 38 contains a list of available structured conversations provided by the conversation applications 36. The contents of the registry 38 are displayed to the participants by the conversation client 26 to enable the initiating participant to choose a type of structured conversation. In one embodiment, the list of available structured conversations may be cached on the clients 24. Examples of the types of conversation applications 36 that provide corresponding structured conversations include a “share a photo album” conversation 36a, a “support representative” conversation 36b, and “a rate this picture” conversation 36c. Many other types of conversation applications 36 for providing different types of structured conversation sessions may be provided, such as inviting others to watch a video together, making a sales pitch that allows participants to buy or ask for additional information or follow-up contact information, collecting survey information, and collecting metadata concerning an image from an expert, for instance.

The conversation applications 36 interface with conversation application databases 40. In a preferred embodiment, each conversation application 36 comprises a plurality of web pages stored in the conversation application databases 40. The web pages may be implemented as active server pages (ASPs), which is a web page that contains HTML and embedded programming code written in a language such as VBScript or JavaScript that is executed in the web server 28 or the conversation applications 36.

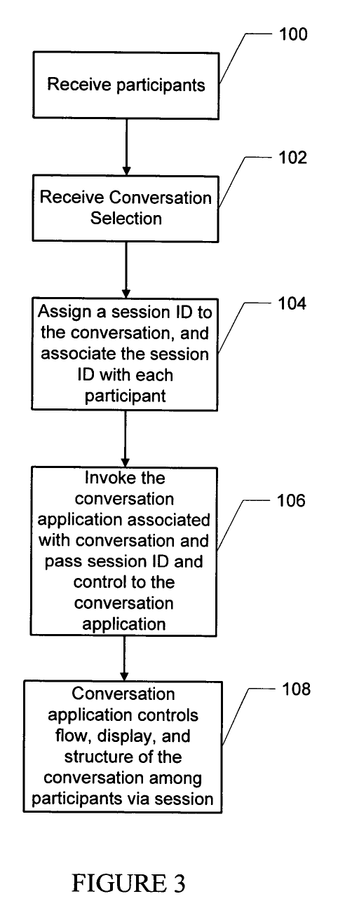

FIG. 3 is a flow diagram illustrating the process for providing structured conversation sessions using conversation applications 36 in one embodiment of the present invention. Referring to both FIGS. 2 and 3, the process assumes that an initiating participant has invoked a conversation client 26 on the client device 24 and that there are one or more other participants online with whom the initiating participant has selected to conduct a real-time conversation, (i.e., a chat session). The process begins when the web server 28 receives the selection of conversation participants from the client device 24 in step 100 and a structured conversation selection indicating the type of conversation to be had in step 102. As stated above, the client list 30 and the list of structured conversations from the conversation registry 38 are displayed by the conversation clients 26 when the initiator begins a conversation. The order of steps 100 and 102 is optional. In addition, the initiating participant may select digital image data such as an image, album, or video to share with the designated participants.

In step 104, the web server 28 assigns a session ID to the conversation and passes the session ID to the conversation manager 32, which associates each participant with the session ID and stores the information in the session database 34. In a preferred embodiment, the records in the session database 34 include an identity of each participant, e.g., (user ID) 42, the session ID 44 of the connection, and a connection ID 46 such as a TCP socket, or in the case where there are no firewalls, an IP address and port number. The record may also include additional information, such as an identifier for each participant's client device 24.

In step 106 the web server 28 invokes the conversation application 36 corresponding to the selected structured conversation and passes the session ID and control of the conversation to the conversation application 36. In step 108, the conversation application 36 controls the flow, display, and structure of conversation among the participants during the session through the display of pages and forms comprising the conversation. The pages and forms sent to the client devices include any selected digital image data and an area for the participants to compose messages.

When the participants enter data into the displayed form, the data is routed to the conversation applications based on the session ID. In one embodiment, the communication can be implemented similar to communication with a web page, where the client device issues HTTP get or an HTTP post command that have parameters associated with them. For example, if a client device is displaying a album, the participant may proceed to the next page by clicking on “next page”. In response, the request is routed to the photo album conversation application 36a, which would retrieve the next page of the photo album, and send that page to each participating client device 24. The conversation applications 36 handle a request from one client device like a web server, but the responses are sent out to more than one client device. The response to each participant may differ depending on their role in the conversation and the state of the conversation.

Thus, the conversation applications 36 of the present invention receive standard HTTP requests from the respective conversation clients 26, but send the pages and forms back to the multiple client devices 24 participating in the conversation. Because the displayed data and forms are controlled by a conversation application, the conversation application 36 provides the participants of a conversation with a limited set of options that limits what the participants can do. Options may include allowing each participant to add comments and metadata to a displayed image or images, to download an image, the ability to print, or the ability to change the other client device's display to for example, zoom in from the album view to a view of a particular picture. The programming code comprising the conversation application 36 provides the processing for the page, such as delivering search data entered on a web page to the database 18 for lookup. It may also format the results of that search as HTML and send it back to the conversation participants.

The conversation applications 36 process the participant input to the conversation to determine display content and format of the pages and forms to be used for the next response. This allows the “flow” of the conversation to be controlled by the conversation application. Input provided by the conversation leader and/or each participant may affect the state of the conversation and thus the output that the conversation application generates for the response.

In a further aspect of the present invention, the pages and forms sent from the conversation application 36 to the client devices 24 may differ. For example, assume a teacher wants to give feedback to students regarding the structure of their photo albums. The initiator of the conversation, the teacher, may see each of the student's albums displayed on the teacher's client device, while each student only sees his or her own album. As another example, the support representative conversation application 36b may display a series of structured questions to the customer, and based on answers to those questions, display a customer support page to a customer support agent and a hardware support page to a hardware support agent with the relevant information provided by the customer. The customer and the two agents may then conduct a three-way conversation driven and controlled by the support representative conversation application 36b. Thus, the replies sent from the conversation applications 36 to the client devices participating in a structured conversation session may be controlled by the initiator of the conversation, either manually or through preference settings, or by decision-making ability written into the conversation application 36 itself.

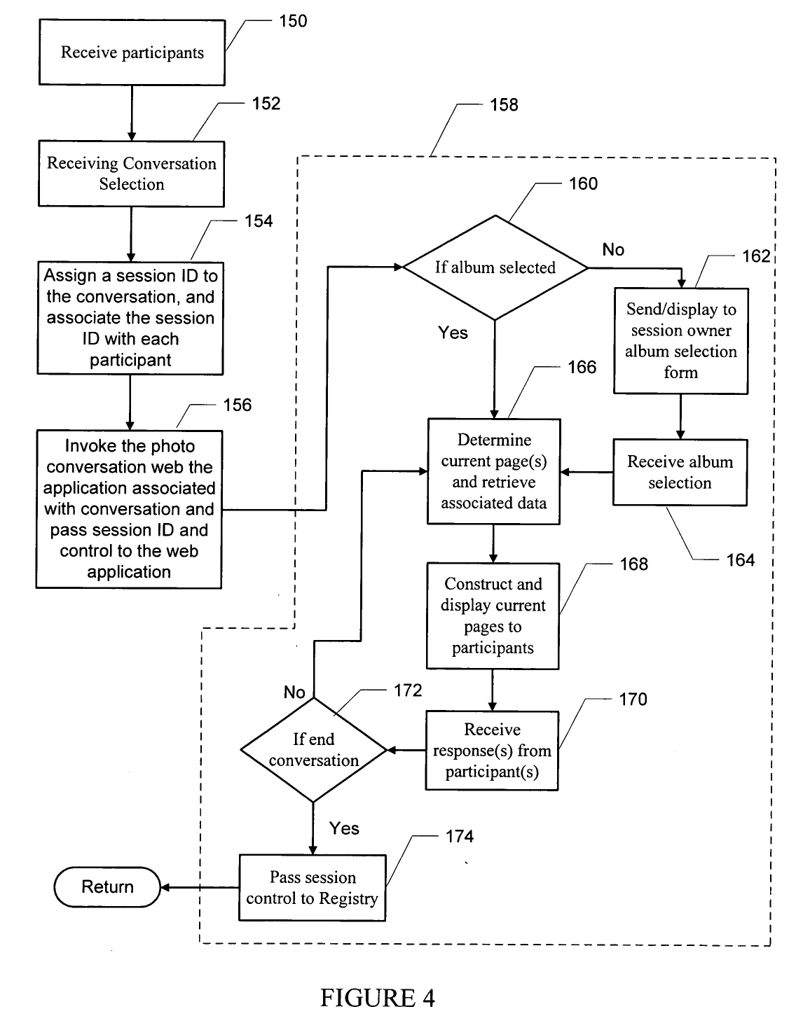

In a preferred embodiment, one of the main purposes of a structured conversation session is to share digital image data during the conversation. FIG. 4 is a flow diagram illustrating the process of a structured conversation session provided by the photo album conversation application 36a in accordance with a preferred embodiment. Steps 150 through 156 correspond to the steps 100 through 106 of FIG. 3 and will not be described here, except that the participant selected a photo sharing conversation in step 152, which invokes the photo conversation application 36a. The sub-steps (shown by dashed lines) of step 158, which corresponds to step 108 of FIG. 3, are shown in further detail.

After the photo conversation album 36a is invoked, in step 160 it is determined if a participant selected an album to share. If the participant did not select an album, then in step 162 the photo conversation album 36a sends and displays to the session owner an album selection form, and the album selection form is received by the client device 24 in step 164.

In step 166, the photo conversation application 36a determines current page(s) to display and retrieves the image data associated with the participant's selection. In step 168, the photo conversation application 36a formats the image data, and constructs and displays the current page(s) to the participants of the structured conversation.

In a preferred embodiment, the photo album conversation application 36a is capable of retrieving and displaying images and albums from either a storage device accessible from the participant's client device, or from an online photosharing site specified by the participant. If the images are stored on an online photosharing site, then the album selection form prompts the participant to supply the URL of the photosharing site and his or her login information. In response to receiving the requested information, the photo album conversation application 36a logs into the specified photosharing site and displays a window on the participant's client device 24 showing the photo albums stored on the site. The participant then selects an album or an image(s). In a preferred embodiment, once the participant selects image data, the photo album conversation application 36a retrieves the selected image data either from the participant's client device or the photosharing site, formats the image data and then outputs the image data to the specified participants based on the display capabilities of the devices 24. In this embodiment, each conversation client 26 reports to the photo album conversation application 36a the display capabilities of the corresponding client device 24.

In step 170, the photo conversation application 36a receives responses from the participants. While the image data is displayed to the participants, the participants can comment on the image data. The photo conversation application 36a collects the comments from each participant and may display the comments to the other participants. In one embodiment, the owner of the image data may indicate to the photo conversation application 36a to have selected comments permanently saved with the image data. Since the data returned to each participant is a page, the initiator has access control for all participants, and the participants may not be given access to the same set of features of the page. For example, a person may set the access control of an album such that his/her mother may comment and print images from the album, but his/her sister may only print images. The participant may specify the access control for other participants by accessing a feature of the conversation client that displays people in the client list 30 and allows the participant to set access control for each person either globally or for a particular item.

In step 172, it is determined if the structured conversation session has ended. If not, the process proceeds to step 166. Otherwise, if the conversation has ended, then control is passed to the registry.

A method and system for a method and system for enabling structured real-time conversations between multiple participants has been disclosed. According to the method and system disclosed herein, the preferred embodiment combines aspects of web applications and chat applications; such that the real-time conversation between two or more people is structured like the interaction with a web site, but it is also interactive because there are at least two people involved, rather than just one person with a web site.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for enabling a structured real-time network communication session for at least two or more client devices, the method comprising:
providing a server with one or more conversation applications that provide respective structured conversation sessions;
displaying a list of available structured conversations on at least one of the client devices for selection; and
in response to the server receiving the selection of one of the structured conversations, passing control of the conversation to the corresponding conversation application.

2. The method of claim 1 further including: managing communication between participants of the client devices by using the real-time communication session to send display content, including input forms, to the client devices to allow the initiating participant to share multimedia objects and text messages with recipient participants, wherein the input forms restrict the participant's input by prompting for specific information at specific states of the conversation, thereby guiding participant responses in a structured manner.

3. The method of claim 2 wherein the real-time network communication session comprises an instant message conversation or a chat conversation.

4. The method of claim 3 further including: receiving by the server a participant's selection of recipient participant in addition to receiving the participant's selection of one of the structured conversations.

5. The method of claim 4 further including: assigning by the server a session ID to the real-time conversation session and associating each participant in a conversation with the session ID.

6. The method of claim 5 further including: storing the participants and the session ID in a database.

7. The method of claim 6 wherein records in the database include an identity of each participant, the session ID, and a connection ID.

8. The method of claim 7 wherein passing control to the conversation application further includes passing the session ID from the server to the conversation application.

9. The method of claim 8 wherein the conversation application send pages and forms to the participants that include any selected digital image data and an area for the participants to compose text messages.

10. The method of claim 9 further including: providing the pages and forms with a limited set of options for the participants including any combination of; allowing each participant to add comments and metadata to a displayed image, to download an image, an ability to print, and an ability to change another client device's display by zooming.

11. The method of claim 10 further including: when the participants enter data into the displayed form, routing the entered the data to the conversation application based on the session ID.

12. The method of claim 11 further including: in response to the conversation application receiving entered data, formatting the entered data and sending the entered data to the other conversation participants.

13. The method of claim 12 further including: processing the entered data to determine display content and format of the pages and forms to be used for a next response.

14. The method of claim 13 further including: formatting the pages and forms to be used for the next response differently for different participants of the conversation.

15. A system for enabling a structured real-time network communication session, comprising:
multiple client devices, each of the multiple client devices being capable of network communication and including a conversation client application that provides real-time communication functionality;
a conversation server in communication with the multiple client devices, the conversation server comprising,
a conversation means for keeping track of participants of a conversation taking place between the client devices, and
a conversation application that uses the communication session to control a structured conversation among participants of the client devices to allow an initiating conversation participant to share multimedia objects and text with multiple other conversation participants, and that prompts the conversation participants to enter specific information at specific states in the conversation, thereby guiding participant responses in a structured manner.

16. The system of claim 15 wherein the real-time network communication session comprises an instant messaging conversation or a chat conversation.

17. The system of claim 16 wherein the conversation server further includes multiple conversation applications for providing different types of structured conversations to the client devices.

18. The system of claim 17 wherein the conversation server further includes a conversation registry that contains a list of available structured conversations provided by the conversation applications, and wherein the list of available structured conversations are displayed to the participants to enable the initiating participant to choose a type of structured conversation.

19. The system of claim 18 wherein the structured conversations provided by the conversation applications include any combination of sharing a photo album, conducting a conversation with a support representative, rating an image, watching a video, making a sales pitch, collecting survey information, and collecting metadata concerning an image.

20. The system of claim 19 wherein the conversation means comprises a list of available clients online, a conversation manager that manages persistent connections between multiple participants, and a conversation database for maintaining records of all the participants involved in open chat sessions.

21. The system of claim 20 wherein all the participants involved in a particular conversation are associated with a session ID.

22. The system of claim 21 wherein the client devices are browser-based, and wherein the conversation server further includes a web server for managing requests from the client devices and delivers HTML documents and files from the conversation applications.

23. A method for enabling a structured real-time network communication session for at two or more client devices, the method comprising:
providing a server with set of conversation applications for providing the client devices with structured conversations;
downloading from the server to at least one of the client devices a list of available structured conversations for display to an initiating participant;
receiving by the server the participant's selection of one of the structured conversations and a selection of other participants for the conversation;
invoking the conversation application corresponding to the selection;
sending invitations to client devices corresponding to selected participants;
associating the participant and each participant that accepted the invitation with the conversation, creating a conversation group; and
invoking the conversation application to manage communication between the conversion group, wherein the conversation application uses the real-time communication session to send display content to the client devices, wherein the display content includes multimedia objects and input forms that restrict the participant's input by prompting for specific information at specific states of the conversation, thereby guiding participant responses in a structured manner.
